(19) United States
(12) Patent Application Publication
(10) Pub. No.: US 2017/0299906 A1
(43) Pub. Date: Oct. 19, 2017

(54) CURVED DISPLAY PANEL AND FABRICATION METHOD THEREOF, AND RELATED DISPLAY APPARATUS

(71) Applicant: BOE TECHNOLOGY GROUP CO., LTD, Beijing (CN)

(72) Inventor: Weili ZHAO, Beijing (CN)

(21) Appl. No.: 15/324,960

(22) PCT Filed: Nov. 19, 2015
(86) PCT No.: PCT/CN2015/095040

§ 371 Date: Jan. 9, 2017

(51) Int. Cl. G02F 1/1339; G02F 1/1333; G02F 1/1335

(52) U.S. Cl. CPC G02F 1/1339; G02F 1/133528; G02F 1/133305; G02F 2201/56; G02F 2001/133538

(57) ABSTRACT

The present disclosure provides a curved display panel. The curved display panel includes a first substrate; a second substrate; a first sealant strip for bonding the first substrate and the second substrate on a first straight side of the first substrate and the second substrate; and a second sealant strip for bonding the first substrate and the second substrate on a first curved side of the first substrate and the second substrate, wherein the first sealant strip has a first intersection with the second sealant strip, the second sealant strip extending from the first intersection towards a non-display region by a first distance.

### FIELD OF THE INVENTION

The present invention generally relates to the display technologies and, more particularly, relates to a curved display panel, a method for fabricating the curved display panel, and the related display apparatus.

### BACKGROUND

Currently, display modes of thin-film transistor liquid crystal display (TFT-LCD) include a vertical alignment (VA) mode, an in-plane-switching (IPS) mode, an advanced super dimension Switch (ADS) mode, etc. The display panels of the horizontal liquid crystal alignment modes (e.g., ADS, IPS, etc.) provide wide viewing angles and are often curved. During the curving process for producing a curved display panel, different curving strain is applied on the display panel, including the front and back substrates (e.g., compressive strain on the front substrate, tensile strain on the back substrate), produces optical axis deviations between the two substrates, which lead to the light leakage problems.

In a curved LCD panel such as an ADS LCD display panel, the front substrate and the back substrate of a curved display panel, often made of glass, are bonded with sealants. The front substrate of the curved display panel, often placed closer to the user when in operation, is usually subjected to a compressive strain. The back substrate of the curved display panel, often placed farther away from the user when in operation, is often subjected to a tensile strain. The front substrate and the back substrate are subjected to different types of strains because the back substrate often surrounds the outer periphery of the front substrate to prevent the front substrate from relaxing to its original shape.

In such a curved display panel, the direction of the compressive strain at or near the center regions of the front substrate may be in the horizontal direction, which often represents a compressive strain of an angle close to 0° or close to 180° (i.e., to the horizontal direction). These regions often have little or no dark state light leakage.

The regions close to the corners of the front substrate may be subjected to compressive strain with an oblique angle, such as 30° or −30°, to the horizontal direction. For example, at the four corners of the front substrate, the direction of the compressive strain may be close to 45° or −45° to the horizontal direction. The angle of 45° or −45′ is often regarded as the angles corresponding to the most light leakage. Similarly, for the back substrate, the direction of the tensile strain at or near the center region of the back substrate may be in the horizontal direction, and the direction of the tensile strain at the four corners of the back substrate may be close to 45° or −45° to the horizontal direction.

In an advanced super dimension switching (ADS) LCD display panel, such strains may cause phase retardation of the light transmitting through the LCD display panel, and may cause increase in the dark state light leakage.

Polarizers are often used to prevent dark state light leakage. However, in existing LCD technologies, the polarizers are not able to substantially or completely reduce the dark state light leakage at the corners of the bonded front substrate and the back substrate. Thus, improvements are sought to further reduce the dark state light leakage, in particular, at the corner regions of the curved display panels.

### BRIEF SUMMARY OF THE DISCLOSURE

The present disclosure provides a curved display panel, a method for fabricating the curved display panel, and a related display apparatus. The disclosed fabrication method is easy to implement. In curved display panels according to the embodiments of the present disclosure, dark state light leakage may be effectively reduced when the size of the active area of the curved display panel remains the same.

One aspect of the present disclosure includes a curved display panel, including a first substrate; a second substrate; a first sealant strip fir bonding the first substrate and the second substrate on a first straight side of the first substrate and the second substrate; and a second sealant strip for bonding the first substrate and the second substrate on a first curved side of the first substrate and the second substrate. The first sealant strip has a first intersection with the second sealant strip, the second sealant strip extending from the first intersection towards a non-display region by a first distance.

The curved display panel further includes a third sealant strip for bonding the first substrate and the second substrate on a second straight side of the first substrate and the second substrate; and a fourth sealant strip for bonding the first substrate and the second substrate on a second curved side of the first substrate and the second substrate. The third sealant strip has a second intersection with the fourth sealant strip, the fourth sealant strip extending from the second intersection towards a non-display region by a second distance. The first sealant strip has a third intersection with the fourth sealant strip and the second sealant strip has a fourth intersection with the third sealant strip. Fourth sealant strip extends from the third intersection towards a non-display region by a third distance. Second sealant strip extends from the fourth intersection towards a non-display region by a fourth distance.

Optionally, the first distance, the second distance, the third distance, and the fourth distance equal to one another.

Optionally, the first sealant strip and the third sealant strip are each positioned away from an outer periphery of a corresponding straight side by a fifth distance. The fifth distance is greater than zero.

Optionally, the first distance, the second distance, the third distance, and the fourth distance are each in a range of about 1 to 10 mm.

Optionally, the first distance, the second distance, the third distance, and the fourth distance are each in a range of about 2 to 5 mm.

Optionally, the first distance, the second distance, the third distance, and the fourth distance are each in a range of about 3.5 to 4.5 mm.

The curved display panel further includes a first polarizer positioned on a surface of the first substrate facing away from the second substrate and a second polarizer positioned on a surface of the second substrate facing away from the first substrate. A polarization of the first polarizer is orthogonal to a polarization of the second polarizer.

Optionally, the first sealant strip and the second sealant strip form a T-shape at the first intersection.

Optionally, the curved display panel further includes liquid crystals and corresponding circuits between the first substrate and the second substrate.

Another aspect of the present disclosure provides a method for fabricating a curved display panel with a first substrate, a second substrate, a first sealant strip, and a second sealant strip. The method includes forming the first sealant strip positioned on a first straight side of one of the first substrate and second substrate; and forming the second sealant strip positioned on a first curved side of the one of the first substrate and second substrate. The first sealant strip has an intersection with the second sealant strip, the second sealant strip extending from the intersection towards a non-display region by a first distance.

The method further includes: forming a third sealant strip positioned on a second straight side of the one of the first substrate and the second substrate; and forming a fourth sealant strip positioned on a second curved side of the one of the first substrate and the second substrate. The third sealant strip has a second intersection with the fourth sealant strip, the fourth sealant strip extending from the second intersection towards a non-display region by a second distance. The first sealant strip has a third intersection with the fourth sealant strip. The second sealant strip has a fourth intersection with the third sealant strip, the fourth sealant strip extending from the third intersection towards a non-display region by a third distance, the second sealant strip extending from the fourth intersection towards a non-display region by a fourth distance.

The method further includes enclosing liquid crystals and corresponding circuits between the first substrate and the second substrate.

Optionally, the first sealant strip and the third sealant strip are each positioned away from an outer periphery of the corresponding straight side by a fifth distance. The fifth distance is greater than zero.

Optionally, the first distance, the second distance, the third distance, and the fourth distance are each in a range of about 1 to 10 mm.

Optionally, the first distance, the second distance, the third distance, and the fourth distance are each in a range of about 2 to 5 mm.

Optionally, the first distance, the second distance, the third distance, and the fourth distance are each in a range of about 3.5 to 4.5 mm.

Another aspect of the present disclosure provides a display apparatus, including one or more of the curved display panels described above.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 (a1) illustrates a cross-sectional view of an existing curved display panel, and FIG. 1 (a2) illustrates a portion of a top view of the curved display panel;

FIG. 2 illustrates an image showing simulated dark state light leakage of the curved display panel shown in FIG. 1 (a1) and FIG. 1 (a2);

FIG. 3 (a1) illustrates a cross-sectional view of an exemplary curved display panel according to the embodiments of the present disclosure, and FIG. 3 (a2) illustrates a portion of a top view of the curved display panel shown in FIG. 3 (a1);

FIG. 4 illustrates an image showing simulated dark state light leakage of the curved display panel shown in FIG. 3 (a1) and FIG. 3 (a2); and

FIG. 5 illustrates an exemplary flow chart for forming the curved display panel according to the embodiments of the present disclosure.

### DETAILED DESCRIPTION

For those skilled in the art to better understand the technical solution of the invention, reference will now be made in detail to exemplary embodiments of the invention, which are illustrated in the accompanying drawings. Wherever possible, the same reference numbers will be used throughout the drawings to refer to the same or like parts.

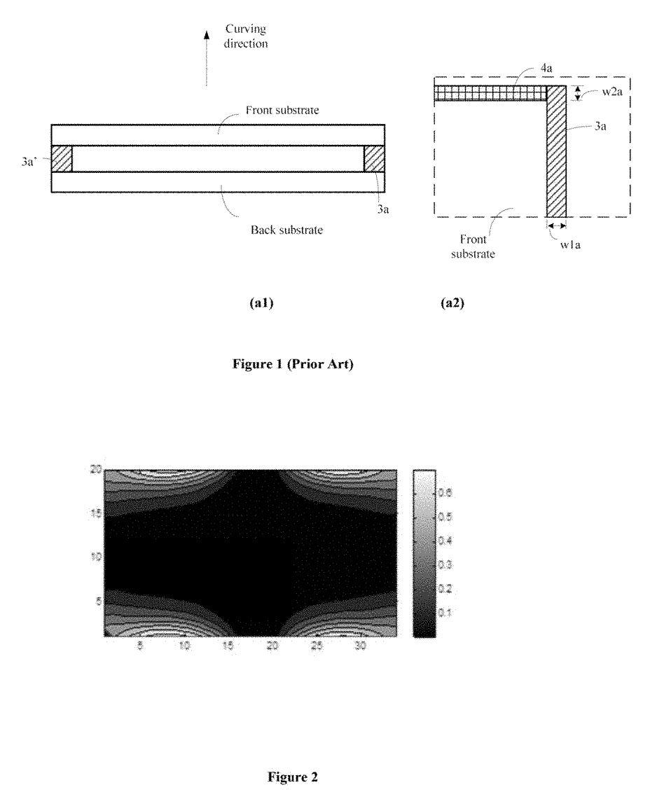

An existing LCD display panel is shown in FIGS. 1 (a1) and (a2). FIG. 1 (a1) is a cross-sectional view of the display panel and FIG. 1 (a2) is the top view of a corner of the display panel. The corner shown in FIG. 1 (a2) is circled in a dashed box. As shown in FIG. 1 (a1) and FIG. 1 (a2), in an existing curved LCD display panel, the front substrate and the back substrate are bonded using a plurality of sealant strips, indicated by 3a and 3a′ in FIG. 1 (a1). The curving or curving direction is illustrated with an arrow in FIG. 1 (a1). 3a and 3a′ are used to illustrate the two sealant strips positioned on the two straight sides of the display panel.

In FIG. 1 (a1), the curved LCD display panel may be an in-plane switching IPS LCD display panel or an ADS LCD display panel. The front substrate may be subjected to compressive strain and the back substrate may be subjected to tensile strain. The sealant strips may be positioned on the peripheries of the bonded front substrate and the back substrate to provide the bonding in between.

FIG. 1 (a2) illustrates a corner of the display panel including the bonded front substrate and back substrate shown in FIG. 1 (a1). The display panel may be bonded by two first sealant strips distributed along the two straight sides not being curved according to the curving direction, and two second sealant strips distributed along the two sides being curved according to the curving direction. A corner of the display panel, including a portion of the first sealant strip and a portion of the second sealant strip is shown in FIG. 1 (a2). A second sealant strip 4a distributed along the side being curved according to the curving direction has no overlap with the first sealant strip 3a distributed along the straight side, at the corner of the display panel. The outer periphery of the first sealant strip 3a may be substantially coplanar with the outer peripheries of the front substrate and the back substrate. The first sealant strip 3a may have a certain width of w1a, and the second sealant strip 4a may have a certain width of w2a.

FIG. 2 illustrates an image of simulated dark state light leakage of the curved display panel shown in FIGS. 1 (a1) and (a2). An area with a lighter color may represent more dark state light leakage, and an area with a darker color may represent less or no dark state light leakage or an area with the light blocked in the dark state, as shown in the gray scale image. According to the simulation, more dark state light leakage may occur at the corner regions of the bonded front substrate and back substrate. The leakage decreases gradually towards the center. Specifically, the most dark state light leakage occurs along the two curved sides of the two substrates.

One aspect of the present disclosure provides a curved display panel. The curved display panel includes a front substrate, a back substrate, an LCD layer and the corresponding circuits, and a plurality of sealant strips for bonding the front substrate and the back substrate and enclosing the LCD layer and the corresponding circuits.

FIG. 3 (a1) illustrates a cross-sectional view of the disclosed curved display panel. FIG. 3 (a2) illustrates the top view of a portion of the curved display panel shown in FIG. 3 (a1), circled in a dashed box. The curving direction is illustrated as the arrow in FIG. 3 (a1). As shown in FIG. 3 (a1), the curved display panel may include a front substrate 1, a back substrate 2, and a plurality of sealant portions such as sealant strips. For illustrative purposes, the sealant portions are illustrated using sealant strips. It should be noted that, the specific shapes of the sealant portions should not be limited by the embodiments of the present disclosure. The sealant strips include a first sealant strip 3, a third sealant strip 3′, a second sealant strip 4, and a fourth sealant strip 4′ (4′ is not shown in FIGS. 3 (a1) and (a2)). The front substrate 1 and the back substrate 2 may both be at least substantially transparent. In FIG. 3 (a1) and (a2), the two straight sides of the front substrate 1 or the back substrate 2, not being curved according to the curving direction, may be referred as the first sides. The two curved sides of the front substrate 1 or the back substrate 2, being curved according to the curving direction, may be referred as the second sides, as shown in FIG. 3 (a2). For illustrative purposes, only a portion of a first side and a portion of a second side are shown in FIG. 3 (a2).

The first sealant strip 3 and the third sealant strip 3′ may represent the sealant strips applied on the two straight sides of the curved display panel for bonding the front substrate 1 and the back substrate 2. The second sealant strip 4 and the fourth sealant strip 4′ may represent the sealant strips applied on the two curved sides of the curved display panel for bonding the front substrate 1 and the back substrate 2. FIG. 3 (a1) shows a cross-sectional view of the first sealant strip 3 and the third sealant strip 3′, and FIG. 3 (a2) shows a top view of a corner of the display panel with a portion of the first sealant strip 3 and a portion of the second sealant strip 4. The outer periphery of the first sealant strips 3 and/or the third sealant strip 3′ may be positioned inwardly from the outer peripheries of the front substrate 1 and the back substrate 2 by a distance of Δw, where w is a positive number. The first sealant strip 3 and the third sealant strip 3′ may each have a width of w1. The area circled or enclosed by the sealant strips may be the display region or active area of the curved display panel. The area outside the periphery of the sealant strips, i.e., the area between the outer periphery of the sealant strips and the outer periphery of the bonded front substrate 1 and back substrate 2, may be non-display regions of the curved display panel, i.e., a region not configured to display images. The display region of the disclosed curved display panel shown in FIG. 3 (a1) may be the same size as the display region of the existing curved display panel shown in FIGS. 1 (a1) and (a2).

A portion of the second sealant strip 4 may be shown in FIG. 3 (a2). The second sealant strip 4 and the fourth sealant strip 4′ may each have a certain width of w2. w2 may be any suitable positive value. Under the curving force, the second sealant strip 4 and the fourth sealant strip 4′ may each have a certain curvature radius, such as 1000-10000 mm. In some embodiments, the curvature radius may be about 3500 mm.

The second sealant strip 4 and the fourth sealant strip 4′ may not overlap with the first sealant strip 3 and third sealant strip 3′ but may intersect with the first sealant strip 3 and the third sealant strip 3′. The second sealant strip 4 and/or the fourth sealant strip 4′ may extend from the intersection with the first sealant strip 3 and/or the third sealant strip 3′ to the corresponding non-display region by a certain distance. For example, the second sealant strip 4 may have a first intersection with the first sealant strip 3. The second sealant strip 4 may extend from the first intersection towards the corresponding non-display region by a first distance. The second sealant strip 4 may have a fourth intersection with the third sealant strip 3′. The second sealant strip 4 may extend from the fourth intersection towards the corresponding non-display region by a fourth distance. The fourth sealant strip 4′ may have a third intersection with the first sealant strip 3, and the fourth sealant strip 4′ may extend from the third intersection towards the corresponding non-display region by a third distance. The fourth sealant strip 4′ may have a second intersection with the third sealant strip 3′, and the fourth sealant strip 4′ may extend from the second intersection towards the corresponding non-display region by a second distance.

The first distance, the second distance, the third distance, and the fourth distance may or may not be equal to one another. The values of the first distance, the second distance, the third distance, and the fourth distance may or may not be zero. That is, the second sealant strip 4 and/or the fourth sealant strip 4′ may or may not extend from the corresponding intersection towards the corresponding non-display region. An end of the second sealant strip 4 or the fourth sealant strip 4′ may be positioned at any suitable position between an outer periphery of the first sealant strip 3 (or the third sealant strip 3′) and the outer periphery of the front substrate 1 (or back substrate 2). In one embodiment, both the second sealant strip 4 and the fourth sealant strip 4′ may extend from the intersections with the first sealant strip 3 and the third sealant strip 3. FIG. 3 (a2) only shows a corner and one end of the second sealant strip 4, extending from the intersection with the first sealant strip 3. The second sealant strip 4 and the fourth sealant strip 4′ may each reach the outer peripheries of the front substrate 1 and the back substrate 2. It should be noted that the terms “first”, “second”, “third”, and “fourth” are only for illustrative purposes and do not indicate any difference in sealant types or other characteristics of the sealant strips.

It can be shown from FIG. 3 (a2) that, when the second sealant strip 4 or the fourth sealant strip 4′ extends from the corresponding intersection towards the corresponding non-display region, the second sealant strip 4 (or the fourth sealant strip 4′) and the first sealant strip 3 (or the third sealant strip 3′) intersecting the second sealant strip 4 (or the fourth sealant strip 4′) may form a “T” shape at the intersection. As shown in FIG. 3 (a2), the second sealant strip 4 and the first sealant strip 3 may have a first intersection. The second sealant strip 4 and the first sealant strip 3 form a “T” shape at the first intersection.

In certain embodiments, only one sealant strip (e.g., the first sealant strip 3) may be applied on a straight side and/or only one sealant strip (e.g., the second sealant strip 4) may be applied on a curved side. In this case, the second sealant strip 4 may have an intersection with the first sealant strip 3, and the second sealant strip 4 may extend from the intersection towards the corresponding non-display region by a certain distance. The second sealant strip 4 and the first sealant strip 3 may form a “T” shape at the intersection.

In embodiments of the present disclosure, the widths (w1, w2) and the distance (Δw) may be adjusted individually or together according to various designs to optimize the reduction of dark state light leakage. Depending on different applications and/or designs, the distance Δw may be in the range of 1 to 10 mm. In certain embodiments, Δw may be about 2 to 5 mm. In certain other embodiments, Δw may be about 3.5 to 4.5 mm.

The first sides of the bonded front substrate 1 and the back substrate 2 may be perpendicular to the second sides of the bonded front substrate 1 and the back substrate 2. The first sides are not being curved along the curving direction and do not have a curvature radius. The first sealant strip 3 and the third sealant strip 3′ may be applied along the two first sides but inwardly from the corresponding periphery of the bonded front substrate 1 and the back substrate 2 by the distance of Δw. The first sealant strip 3 and the third sealant strip 3′ may be of any suitable width, and the distance Δw may be any suitable positive value. In one embodiment, Δw may be about 4 mm. For illustrative purposes, FIG. 3 (a2) only shows a portion of a first side and a portion of a second side.

In some embodiments, the first sealant strip 3, the third sealant strip 3′, the second sealant strip 4, and the fourth sealant strip 4′ may be applied on one of the front substrate 1 and the back substrate 2 in one fabrication step. The first sealant strip 3, third sealant strip 3′, the second sealant strip 4, and the fourth sealant strip 4′ may each have a uniformed thickness. In some embodiments, w1 may equal to w2 and be 1 mm. The first sealant strip 3, the third sealant strip 3′, the second sealant strip 4, and fourth sealant strip 4′ may have the same thickness.

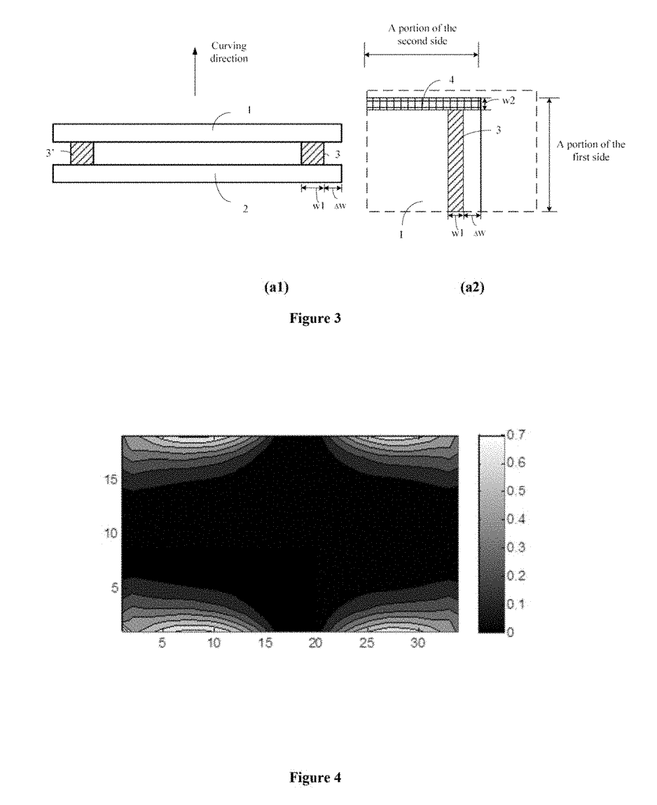

FIG. 4 illustrates the image of a simulated dark state light leakage of the disclosed curved display panel shown in FIG. 3 (a1) and (a2). An area with a lighter color may represent more dark state light leakage, and an area with black color may represent no dark state light leakage or an area with the light blocked in the dark state, as shown in the gray scale image. As shown in FIG. 4, the dark state light leakage of the curved display panel may be close to the four corners of the curved display panel. The dark state light leakage may be the most along the second sides and decrease gradually towards the center of the bonded front substrate 1 and back substrate 2. Compared to the simulated dark state light leakage image of the curved LCD display panel shown in FIG. 2, the simulated dark state light leakage for the disclosed curved display panel is less, as shown in FIG. 4. That is, FIG. 4 may contain fewer areas with lighter colors. In a simulated dark state light leakage image, more areas with darker colors and/or fewer areas with lighter colors may indicate a more desirable light blocking performance.

In some embodiments, in an ADS curved display panel, the strains applied on the front substrate and the back substrate may cause phase retardation of the light when the light transmits through the color filter layer of the display panel. Higher phase retardation may cause more dark state light leakage. Thus, reducing the phase retardation of the light reduces the dark state light leakage. Also, reducing the angle between the direction of the strain and the horizontal liquid crystal alignment direction may also reduce dark state light leakage.

A comparison of the characteristics between an exemplary curved display panel of the present disclosure and an exemplary existing curved display panel is summarized in Table 1 below.

| | Existing curved display | Disclosed curved display |
|---|---|---|
| | panel | panel |
| Panel size/mm | 420 × 240 | 420 × 240 |
| Sealant width/mm | 1 | 1 |
| Curvature | 3500 | 3500 |
| radius/mm | | |
| LL/% | 0.5634 | 0.5266 |
| Ret./nm | 8.4 | 8.2119 |
| Axis/° | 26.31 | 25.91 |
| Relative LL/% | 100 | 93.5 |
| Relative ret./% | 100 | 97.8 |
| Relative axis/% | 100 | 98.5 |

As shown in Table 1, the existing curved display panel and the curved display panel of the present disclosure may be of the same size: 420 mm×240 mm. The width of a sealant strip applied on a straight side of one of the front substrate 1 and the back substrate 2 (i.e., 3, 3′, 3a, or 3a′, in FIGS. 1 and 3) and the width of a sealant strip applied on a curved side of one of the front substrate 1 and the back substrate 2 (e.g., 4 or 4a, in FIGS. 1 and 3) may also be 1 mm. The curvature radii of existing curved display panel and the disclosed curved display panel may both be 3500 mm. LL may represent light leakage or dark state light leakage, such as the percentage of dark state light leakage in the curved display panel. As shown in Table 1, the existing curved display panel may have a dark state light leakage of 0.5634%, and the disclosed curved display panel may have a dark state light leakage of 0.5266%. The phase retardation of the light, represented by Ret. in Table 1, may be 8.4 nm in the exemplary existing curved display panel. The phase retardation of the light may be 8.2119 nm in the disclosed curved display panel. The angle between the direction of the strain distributed in the corner of the display panel and the horizontal direction, represented by Axis in Table 1, may be 26.31° in the existing curved display panel and may be 25.91° in the curved display panel of the present disclosure. Accordingly, in the curved display panel of the present disclosure, the phase retardation of the light and the angle between the direction of the strain distributed in the corner of the display panel and the horizontal direction may both be reduced, which reduces the dark state light leakage.

In other words, assuming the dark state light leakage, the phase retardation of the light, and the angle between the direction of the strain and the horizontal direction are 100% in the existing curved display panel in Table 1, the dark state light leakage, the phase retardation of the light, and the angle between the direction of the strain distributed in the corner of the display panel and the horizontal direction in the disclosed curved display panel are 93.5%, 97.8%, and 98.5%, respectively. That is, in the disclosed curved display panel, the phase retardation of the light is reduced by 2.2%, the angle between the direction of the strain distributed in the corner of the display panel and the horizontal direction is reduced by 1.5%, and the dark state light leakage is reduced by 6.5%.

In embodiments of the present disclosure, at the center of the display panel, the angle between the direction of the strain distributed in the front substrate 1 and the back substrate 2 and the horizontal direction may approach 00 or 180°. The strain distribution at the corners of the display panel can be adjusted so that the front substrate 1 and the back substrate 2 may be subjected to less strain. Thus, with the active display area remaining the same size, the disclosed curved display panel may be easy to implement, and may have less dark state light leakage.

The LCD layer and the corresponding circuits may be contained in the space enclosed by the front substrate 1, the back substrate 2, and the sealant strips 3, 3′, 4, and 4′. In some embodiments, the front substrate 1 may be the color filter substrate or a transparent conductive thin substrate, and the back substrate 2 may be a transparent thin-film substrate.

In certain embodiments, the disclosed curved display panel may further include a plurality of polarizers. A first polarizer may be placed on the upper surface of the front substrate 1. The upper surface may refer to the surface facing away from the back substrate 2. A second polarizer may be placed on the lower surface of the back substrate 2. The lower surface may refer to the surface facing away from the front substrate 1.

In one example, the first polarizer may be referred to as a top polarizer. The second polarizer may be referred to as a bottom polarizer. The front substrate 1 may be a top glass plate. The back substrate 2 may be a bottom glass plate. An exemplary curved display panel according to the present disclosure may include a top polarizer, a curved top glass plate, a color filter, a liquid-crystal layer, a thin-film transistor layer including an array of thin-film transistors, a curved bottom glass plate, and a bottom polarizer. The color filter and the liquid-crystal layer, and the thin-film transistor array are sandwiched between the curved top glass plate and the curved bottom glass plate. The top polarizer may be located on an opposite surface of the curved top glass plate to the color filter, and the bottom polarizer may be located at an opposite surface of the curved bottom glass plate to the thin-film transistor layer.

The polarization directions of the two polarizers may be orthogonal to each other. When in the dark state, because the two polarizers may be orthogonal to each other, light transmitting through the first polarizer, the front substrate 1, the LCD layer, and/or the back substrate 2 would not transmit through the second polarizer. Similarly, light transmitting through the second polarizer, the back substrate 2, the LCD layer, and/or the front substrate 1 should also not transmit through the first polarizer. Thus, the polarizers further reduce the dark state light leakage.

It should be noted that, because the second sides may be curved and may have the most dark state light leakage, the arrangement or designs of the sealant strips of the present disclosure can change or re-distribute the strain on the bonded front substrate and the back substrate. By applying the disclosed sealant strips, strain distribution on the curved display panel may be improved and dark state light leakage may be reduced.

Another aspect of the present disclosure provides a method for fabricating a curved display panel.

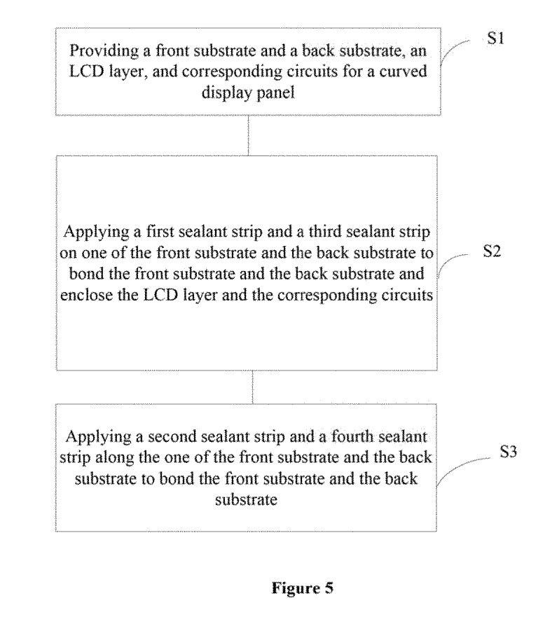

FIG. 5 illustrates an exemplary process of the fabrication method. The process may include steps S1 to S3.

In step S1, a front substrate, a back substrate, an LCD layer and the corresponding circuits of a curved display panel are provided.

As shown in FIG. 3 (a1) and FIG. 5, the front substrate 1 and a back substrate 2 may be provided. The front substrate 1 may be facing the user. The back substrate 2 may be facing away from the user. The front substrate 1 and the back substrate 2 may be curved along the curving direction, shown as the arrow in FIG. 3 (a1). The front substrate 1 may be the color filter substrate or a transparent conductive thin substrate, and the back substrate 2 may be a transparent thin-film substrate. The LCD layer and the corresponding circuits may be sealed between the front substrate 1 and the back substrate 2.

In step S2, a first sealant strip and a third sealant strip are applied on one of the front substrate and the back substrate to bond the front substrate and the back substrate and enclose the LCD layer and the corresponding circuits. The first sealant strip may be labeled as 3 and the third sealant strip may be labeled as 3′, each applied along a straight side of one of the front substrate 1 and the back substrate 2, the straight sides not being curved along the curving direction. Each sealant strip may be positioned away from the corresponding periphery of the bonded front substrate 1 and the back substrate 2 by a certain distance.

As shown in FIG. 3 (a1) and FIG. 5, the first sealant strip 3 and the third sealant strip 3′ may be formed on one of the front substrate 1 and the back substrate 2 to provide bonding between the substrates. The first sealant strip 3 and third sealant strip 3′ may each have a width of w1. The first sealant strip 3 and the third sealant strip 3′ may be positioned away from the corresponding periphery of the bonded front substrate 1 and the back substrate 2 by a distance of Δw, where Δw may be a suitable positive number. In one embodiment, w1 may be about 1 mm and Δw may be about 4 mm.

The first sealant strip 3 and the third sealant strip 3′ may be formed of any suitable encapsulation material such as frit and/or adhesives. The first sealant strip 3 and the third sealant strip 3′ may be formed by any suitable depositing process and patterning process. For example, the first sealant strip 3 and the third sealant strip 3′ may be formed by spraying or spin-on coating a layer of sealant material. The layer of sealant material may be patterned by photolithography followed by an etch so that the two sealant strips may each be placed at a distance of Δw away from the corresponding periphery of the bonded front substrate 1 and back substrate 2, as shown in FIG. 3 (a1). The directions of the strains distributed in the corners and the horizontal direction may be changed accordingly. The distribution of the first sealant strip 3 and the third sealant strip 3′ may reduce the strains distributed in the corners of the front substrate 1 and the corners of the back substrate 2. The dark state light leakage of the curved display panel may be reduced.

In step S3, a second sealant strip and a fourth sealant strip are applied on the one of the front substrate and the back substrate. The second sealant strip may be labeled as 4 and the fourth sealant strip may be labeled as 4′, each applied along a side perpendicular to the sealant strips applied on the straight sides. As shown in FIG. 3 (a2), when in operation, the sides distributed with the second sealant strip 4 and the fourth sealant strip 4′ may be curved along the curving direction. Further, as shown in FIG. 3 (a2), the second sealant strip 4 and the fourth sealant strip 4′ may be formed on the periphery of the curved display panel and may be perpendicular to the first sealant strip 3 and the third sealant strip 3′. The second sealant strip 4 and the fourth sealant strip 4′ may have no overlap but may intersect with the first sealant strip 3 and/or the third sealant strip 3′. The second sealant strip 4 and/or the fourth sealant strip 4′ may have a width of w2, which can also be any other suitable positive value according to different applications or designs. In one embodiment, w2 may be 1 mm. The second sealant strip 4 and/or the fourth sealant strip 4′ may extend from the intersection with the first sealant strip 3 and/or the third sealant strip 3′ to the corresponding non-display region by a certain distance.

For example, second sealant strip 4 may have a first intersection with the first sealant strip 3. The second sealant strip 4 may extend from the first intersection towards the corresponding non-display region by a first distance. The second sealant strip 4 may have a fourth intersection with the third sealant strip 3′. The second sealant strip 4 may extend from the second intersection towards the corresponding non-display region by a fourth distance. The fourth sealant strip 4′ may have a third intersection with the first sealant strip 3. The fourth sealant strip 4′ may extend from the third intersection towards the corresponding non-display region by a third distance. The fourth sealant strip 4′ may have a second intersection with the third sealant strip 3′. The fourth sealant strip 4′ may extend from the second intersection towards the corresponding non-display region by a second distance. The first distance, the second distance, the third distance, and the fourth distance may or may not be equal to one another. The values of the first distance, the second distance, the third distance, and the fourth distance may or may not be zero. That is, the second sealant strip 4 and/or the fourth sealant strip 4′ may or may not extend from the corresponding intersection to the corresponding non-display region. An end of the second sealant strip 4 (or the fourth sealant strip 4′) may be positioned at any suitable position between an outer periphery of the first sealant strip 3 (or the third sealant strip 3′) and the outer periphery of the front substrate 1 (or back substrate 2). In one embodiment, both the second sealant strip 4 and the fourth sealant strip 4′ may extend the intersections with the first sealant strip 3 and the third sealant strip 3. FIG. 3 (a2) only shows a corner and one end of the second sealant strip 4, extending from the intersection with the first sealant strip 3. The second sealant strip 4 and 4′ may each reach the outer peripheries of the front substrate 1 and the back substrate 2.

When the second sealant strip 4 or the fourth sealant strip 4′ extends from the corresponding intersection towards the corresponding non-display region, the second sealant strip 4 or the fourth sealant strip 4′ and the sealant strip intersecting the second sealant strip or the fourth sealant strip 4′ may form a “T” shape at the intersection. As shown in FIG. 3 (a2), the second sealant strip 4 and the first sealant strip 3 may have a first intersection, and the second sealant strip 4 and the first sealant strip 3 form a “T” shape at the first intersection.

In certain embodiments, only one first sealant strip may be formed on a straight side and only one second sealant strip may be formed on a curved side. In this case, the second sealant strip may have an intersection with the first sealant strip, and the second sealant strip may extend from the intersection towards the corresponding non-display region by a certain distance. The second sealant strip 4 and the first sealant strip 3 may form a “T” shape at the intersection.

In some embodiments, w2 may be equal to w1. In certain embodiments, the second sealant strip 4 and the fourth sealant strip 4′ may also be formed away from the corresponding periphery of the bonded front substrate 1 and the back substrate 2 by a certain distance. The second sealant strip 4 and the fourth sealant strip 4′ may be formed using any suitable process and may be made of any suitable materials. In some embodiments, the second sealant strip 4 and the fourth sealant strip 4′ may be formed using the same process and same material to form the first sealant strip and the third sealant strip and is not repeated herein.

It should be noted that, steps S1, S2, and S3 may be executed in a different sequence or may be combined. The first sealant strip 3 and/or the third sealant strip 3′ may be formed before or after the second sealant strip 4 and/or the fourth sealant strip 4′ are formed, and the LCD layer may be deposited on one of the front substrate 1 and the back substrate 2 before or after the sealant strips are formed. The LCD layer and the sealant strips may also be formed in one fabrication step. That is, the first sealant strip 3, the second sealant strip 4, the third sealant strip 3′, and the fourth sealant strip 4′ maybe formed in a same step, and the LCD layer may be formed in a same step or a different step.

It should also be noted that, a patterning process may also be performed before or after the deposition of the sealant material so that the sealant material can be deposited to include the desired pattern. The deposition process and patterning process for forming the first sealant strip, the second sealant strip, the third sealant strip, and the fourth sealant strip may be subject to different applications and should not be limited by the embodiments herein.

It should also be noted that, for illustrative purposes, in the disclosure, only four sealant strips are formed to surround the display region of the display panel for encapsulation. In practice, more than two sealant strips may be formed on a curved side or a straight side according to different applications or designs. Details of the configurations and/or arrangement may be referred to the description above and are not repeated herein.

In certain embodiments, a pressing process may be performed to press the front substrate 1 and the back substrate 2 after the sealant strips are formed to enhance the bonding between the front substrate 1 and the back substrate 2.

The LCD layer and corresponding circuits such as the thin-film transistor circuits may be enclosed or encapsulated in the space formed by the front substrate 1, the back substrate 2, the first sealant strip 3, the third sealant strip 3′, the second sealant strip 4, and the fourth sealant strip 4′. The LCD layer may correspond to the active area of the curved display panel and may be used for displaying images.

Thus, by implementing the disclosed fabrication method, a curved display panel with reduced dark state light leakage may be produced. The active area of the formed curved display panel may be the same as the active area of an existing curved display panel. The method is easy to implement and can be used to reduce the dark state light leakage of the curved display panel.

Another aspect of the present disclosure provides a display apparatus. The display apparatus may include one or more of the described display panel. The display apparatus may be any device or product with display functions such as, an LCD panel, an electronic paper, an OLED panel, a smart phone, a tablet computer, a television, a monitor, a laptop computer, a digital picture frame, and a navigation device, etc.

It should be understood that the above embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

1-18. (canceled)

19. A curved display panel, comprising:
a first substrate;
a second substrate;
a first sealant strip for bonding the first substrate and the second substrate on a first straight side of the first substrate and the second substrate; and
a second sealant strip for bonding the first substrate and the second substrate on a first curved side of the first substrate and the second substrate, wherein:
the first sealant strip has a first intersection with the second sealant strip, the second sealant strip extending from the first intersection towards a non-display region by a first distance.

20. The curved display panel according to claim 19, further including:
a third sealant strip for bonding the first substrate and the second substrate on a second straight side of the first substrate and the second substrate; and
a fourth sealant strip for bonding the first substrate and the second substrate on a second curved side of the first substrate and the second substrate, wherein:
the third sealant strip has a second intersection with the fourth sealant strip, the fourth sealant strip extending from the second intersection towards a non-display region by a second distance; and
the first sealant strip has a third intersection with the fourth sealant strip and the second sealant strip has a fourth intersection with the third sealant strip, the fourth sealant strip extending from the third intersection towards a non-display region by a third distance, the second sealant strip extending from the fourth intersection towards a non-display region by a fourth distance.

21. The curved display panel according to claim 20, wherein the first distance, the second distance, the third distance, and the fourth distance equal to one another.

22. The curved display panel according to claim 20, wherein the first sealant strip and the third sealant strip are each positioned away from an outer periphery of a corresponding straight side by a fifth distance, where the fifth distance is greater than zero.

23. The curved display panel according to claim 20, wherein the first distance, the second distance, the third distance, and the fourth distance are each in a range of about 1 to 10 mm.

24. The curved display panel according to claim 20, wherein the first distance, the second distance, the third distance, and the fourth distance are each in a range of about 2 to 5 mm.

25. The curved display panel according to claim 20, wherein the first distance, the second distance, the third distance, and the fourth distance are each in a range of about 3.5 to 4.5 mm.

26. The curved display panel according to claim 19, further including a first polarizer positioned on a surface of the first substrate facing away from the second substrate and a second polarizer positioned on a surface of the second substrate facing away from the first substrate, a polarization of the first polarizer being orthogonal to a polarization of the second polarizer.

27. The curved display panel according to claim 19, wherein the first sealant strip and the second sealant strip form a T-shape at the first intersection.

28. The curved display panel according to claim 19, further including liquid crystals and corresponding circuits between the first substrate and the second substrate.

29. A method for fabricating a curved display panel with a first substrate, a second substrate, a first sealant strip, and a second sealant strip, comprising:
forming the first sealant strip positioned on a first straight side of one of the first substrate and second substrate; and
forming the second sealant strip positioned on a first curved side of the one of the first substrate and second substrate, wherein:
the first sealant strip has an intersection with the second sealant strip, the second sealant strip extending from the intersection towards a non-display region by a first distance.

30. The method according to claim 29, further including:
forming a third sealant strip positioned on a second straight side of the one of the first substrate and the second substrate; and
forming a fourth sealant strip positioned on a second curved side of the one of the first substrate and the second substrate, wherein:
the third sealant strip has a second intersection with the fourth sealant strip, the fourth sealant strip extending from the second intersection towards a non-display region by a second distance; and
the first sealant strip has a third intersection with the fourth sealant strip and the second sealant strip has a fourth intersection with the third sealant strip, the fourth sealant strip extending from the third intersection towards a non-display region by a third distance, the second sealant strip extending from the fourth intersection towards a non-display region by a fourth distance.

31. The method according to claim 30, further including:
enclosing liquid crystals and corresponding circuits between the first substrate and the second substrate.

32. The method according to claim 30, wherein the first sealant strip and the third sealant strip are each positioned away from an outer periphery of the corresponding straight side by a fifth distance, where the fifth distance is greater than zero.

33. The method according to claim 30, wherein the first distance, the second distance, the third distance, and the fourth distance are each in a range of about 1 to 10 mm.

34. The method according to claim 30, wherein the first distance, the second distance, the third distance, and the fourth distance are each in a range of about 2 to 5 mm.

35. The method according to claim 30, wherein the first distance, the second distance, the third distance, and the fourth distance are each in a range of about 3.5 to 4.5 mm.

36. A display apparatus, including the curved display panel of claim 19.
